(19) United States
(12) Patent Application Publication
(10) Pub. No.: US 2014/0279332 A1
(43) Pub. Date: Sep. 18, 2014

(54) SYSTEMS AND METHODS FOR CONFIGURING AND CONTROLLING FINANCIAL ACCOUNT PRODUCTS

(71) Applicant: Thomas Poole, Chantilly, VA (US)

(72) Inventor: Thomas Poole, Chantilly, VA (US)

(73) Assignee: CAPITAL ONE FINANCIAL CORPORATION, McLean, VA (US)

(21) Appl. No.: 14/204,279

(22) Filed: Mar. 11, 2014

Related U.S. Application Data
(60) Provisional application No. 61/781,848, filed on Mar. 14, 2013.

(51) Int. Cl. G06Q 20/34

(52) U.S. Cl. CPC G06Q 20/354
USPC 705/35

(57) ABSTRACT

In one embodiment, a system configured to configure an inactive financial account is provided. The system, which may be a mobile device, may include one or more memory devices storing software instructions, and one or more processors configured to execute the software instructions to perform one or more operations. The processor(s) may be configured to receive from a server financial account configuration option data relating to a configurable inactive financial account product. The one or more processors may also generate and display interface(s) for activating the inactive financial account product, and receive input through the one or more interfaces to activate the inactive general financial account product. The processor(s) may further generate user selected financial account configuration option data based on the input, and provide the data to the server for configuring and activating the inactive financial account product in accordance with the input.

### PRIORITY CLAIM

This application claims priority under 35 U.S.C. §119 to U.S. Provisional Application No. 61/781,848, filed on Mar. 14, 2013, which is expressly incorporated herein by reference in its entirety.

### TECHNICAL FIELD

The disclosed embodiments generally relate to systems and methods for providing a financial account product, and more particularly, systems and methods for configuring and controlling financial account products.

### BACKGROUND

Typically, financial service providers, such as a bank or credit card company, offer specific types of financial accounts to consumers. For example, a consumer may receive an offer and approval for a new credit card from a credit card company, where the financial account and its account parameters (e.g., APR, credit limit, etc.) may be determined at the time of approval. The approved consumer may receive in the mail a financial card product (e.g., a plastic credit card) that is configured in accordance with the approved account parameters. Before the approved account and card can be used for purchases, the consumer is typically required to activate the card and the account by calling a representative of the account provider, sometimes from a home telephone. The activation process may involve speaking with a representative of the account provider or providing input to an automated telephone activation service. The activation process may be burdensome, restrictive, and annoying to consumers. Some providers may offer consumers an option of activating a newly issued card over the Internet. However, this option may also be burdensome because it requires a consumer to access the account provider's website, follow links, and enter account and personal information to complete the activation process. Moreover, whether over the telephone or the Internet, conventional activation processes do not provide consumers with the option to adjust the type of card or its parameters after it is received from the account provider.

Further, current financial account configurations require a consumer to contact the service provider when a financial card is lost, stolen, or misplaced. This may be difficult for consumers who have misplaced the contact information for the service provider or the account information of the missing card. Sometimes, this missing information may cause delays in reporting the incident to the service provider, which may result in unauthorized use of the card by others and, thus, losses to the consumer and/or financial account provider.

Thus, current financial account management processes do not offer consumers an efficient and user-friendly way of activating financial account cards or reporting the loss or theft of such cards. These processes also do not provide a versatile process where the financial card can be configured or reconfigured by the consumers after receiving the card from the account provider. The disclosed embodiments address these and other drawbacks of current financial account management processes.

### SUMMARY

The disclosed embodiments include systems, methods, and articles of manufacture for providing a financial account product (e.g., plastic or similar financial account card) that is configurable by a user after it is received from a financial service provider. In certain aspects, the disclosed embodiments may allow a user to activate a financial account card (preconfigured or user configurable) using a mobile application that is stored and executed by a mobile device. In other aspects, the disclosed embodiments may allow a user to selectively configure a received financial card product into one of many types of financial accounts. For example, the disclosed embodiments may allow a user to configure a generic financial card product received from a financial service provider (or other type of entity, such as a merchant) to be associated with a credit card account, a line of credit, a loan account (e.g., generic loans or specific loans, such as an automobile loan), a debit account, or any other type of financial account that may be offered by the issuing entity. In one embodiment, the user may configure or select preconfigured parameters for the generic card, such as credit limit, interest rates, penalty attributes (e.g., late fee parameters, etc.), reward parameters, etc. The disclosed embodiments include, for example, a mobile application that generates interfaces on the display of a mobile device that provides options for a user to configure the generic card.

In other aspects, the disclosed embodiments provide mechanisms that enable a user to permanently shut down or temporarily lock a financial account (and associated financial account product (e.g., a plastic account card)) such that use of the account and account product is blocked, permanently or for a determined period of time. For example, aspects of the disclosed embodiments include processes and systems that enable a user to temporarily lock the use of a designated financial account (and account product) for a determined period of time (e.g., minutes, hours, days, etc.) or until a determined date. After the determined time period, use of the financial account and account product may resume in accordance with the disclosed embodiments. In other aspects, exemplary systems and process may enable a user to dynamically lock and unlock a designated financial account and associated product. In another embodiment, a user may configure account settings that automatically lock a designated financial account and account product based on one or more conditions, such as use of the account in a geographic location outside a designated zone (e.g., one or more designated zip codes, etc.). These and other aspects of the disclosed embodiments are described herein.

For example, the disclosed embodiments include a system that may configure an inactive financial account. The system, which may be a mobile device, may include one or more memory devices storing software instructions, and one or more processors configured to execute the software instructions to perform one or more operations. In one aspect, the processor(s) may be configured to receive financial account configuration option data from a server, the financial account configuration option data relating to a configurable inactive financial account product that is provided to a user. The one or more processors may also generate and display one or more interfaces for activating the inactive financial account product. The one or more processors may receive input through the one or more interfaces to activate the inactive general financial account product. The processor(s) may further generate user selected financial account configuration option data based on the input and provide the user selected financial account configuration option data to the server such that the server configures and activates the inactive financial account product in accordance with the user's input.

The disclosed embodiments may also include a computer-implemented method for configuring a financial account that includes receiving, by one or more processors, financial account configuration option data from a server, the financial account configuration option data relating to a configurable inactive financial account product that is provided to a user. The method may also include generating and displaying, by the one or more processors, one or more interfaces for activating the inactive financial account product and receiving, by the one or ore processors, input through the one or more interfaces to activate the inactive general financial account product. The method may also include generating, by the one or more processors, user selected financial account configuration option data based on the input and providing, by the one or more processors, the user selected financial account configuration option data to the server such that the server configures and activates the inactive financial account product in accordance with the user's input.

The disclosed embodiments may also include a system for controlling a financial account, comprising one or more memory devices storing software instructions and one or more processors configured to execute the software instructions to provide a first interface on a mobile device that includes options for a user to shut down a designated financial account, lock the financial account, unlock the financial account, or configure automatic locking of the financial account. The one or more processors may receive a selection from the user of one of the options and provide the user's selection to a server for configuring the designated financial account such that use of the designated financial account is selectively controlled based on the user's selected option.

The disclosed embodiments may further include a system for controlling a financial account. The system may include one or more memory devices storing software instructions and one or more processors configured to execute the software instructions to, for example, receive a first selection from a user of a financial account. The one or more processors may also generate and display one or more interfaces for enabling the user to control the use of the financial account and receive input from the user through the one or more interfaces to control the use of the financial account. In one embodiment, the input received by the user through the one or more interfaces includes input to configure usage limits for the financial account identified by the user. The one or more processors may further be configured to generate user selected financial account configuration option data based on the usage limits provided by the user and provide the user selected financial account configuration option data to a server such that the server controls use of the inactive financial account product in accordance with the user's provided usage limits.

In another embodiment, the usage limits may include merchant type usage limits, merchant name usage limits, payment amount usage limits, or time period limitation usage limits. In another aspect, merchant type usage limits may include information indicating that use of the financial account product is precluded at one or more types of merchants identified by the user. In another aspect, the merchant type usage limits may include information indicating that use of the financial account product is allowed at one or more types of merchants identified by the user. In one embodiment, the payment amount usage limits may include information indicating that use of the financial account product involving a financial transaction over a predetermined purchase amount is not allowed. In another aspect, the payment amount usage limits may include information indicating that use of the financial account product involving a financial transaction under a predetermined purchase amount is allowed. In another embodiment, the time period limitation usage limits may include information indicating that use of the financial account product involving a financial transaction is not allowed during a determined period of time, a determined day of week, a determined time of day, or before a determined date. Alternatively, the time period limitation usage limits may include information indicating that use of the financial account product involving a financial transaction is allowed during a determined period of time, a determined day of week, a determined time of day, or on a determined date.

In another aspect, the merchant name usage limits may include information indicating that use of the financial account product is allowed at one or more merchants identified by the user. In another embodiment, the merchant name usage limits may include information indicating that use of the financial account product is not allowed at one or more merchants identified by the user.

Although disclosed embodiments are discussed primarily in the context of mobile devices and software instructions that are executed by mobile devices, other implementations are contemplated. For example, disclosed embodiments may include software instructions that are executed by a computing system, such as a desktop computer, a server or servers, etc. Moreover, the configuration and architecture, etc. of the computing systems, mobile or non-mobile, are not limiting to the disclosed embodiments. Systems or components that execute software instructions to perform one or more operations consistent with the disclosed embodiments and/or store information generated and/or used by the disclosed embodiments, may be particularly configured to perform the one or more particular operations consistent with the disclosed embodiments.

Further, although the disclosed embodiments are discussed primarily in the context of financial accounts, such as credit card accounts, debit accounts, loan accounts, etc., the disclosed embodiments may be applicable with other types of accounts. For example, disclosed embodiments may be also used with other types of cards, accounts, financial accounts, and the like, such as bank accounts (e.g., savings, checking, etc.), loyalty cards, private label accounts, travel membership accounts (e.g., airline mileage membership accounts), government, organizational, or business issued identification or security accounts or cards, and the like.

It is to be understood that both the foregoing general description and the following detailed description are exemplary and explanatory only and are not restrictive of the disclosed embodiments, as claimed.

The accompanying drawings, which are incorporated in and constitute a part of this specification, illustrate disclosed embodiments and, together with the description, serve to explain the disclosed embodiments.

### BRIEF DESCRIPTION OF THE DRAWINGS

FIG. 1 illustrates an exemplary system consistent with disclosed embodiments.

FIG. 2 is a block diagram of an exemplary financial service provider computing system, consistent with disclosed embodiments.

FIG. 3 is a block diagram of an exemplary client computing system, consistent with disclosed embodiments.

FIG. 4 is a diagram of an exemplary system and process flows associated with certain disclosed embodiments.

FIG. 5 is a diagram of another exemplary system and process flows associated with certain disclosed embodiments.

FIG. 6 is a flow chart of an exemplary financial service provider remote control configuration process, consistent with certain disclosed embodiments.

FIG. 7 is a block diagram of an exemplary data structure relationship including financial account parameter information, consistent with certain disclosed embodiments.

FIG. 8 is a block diagram of an exemplary data structure relationship including parameter options, consistent with certain disclosed embodiments.

FIG. 9 is a flowchart of an exemplary client remote control configuration process, consistent with disclosed embodiments.

FIG. 10 is a flowchart of an exemplary financial account parameter selection process, consistent with disclosed embodiments.

FIG. 11 is a block diagram of an exemplary mobile device client and associated interface associated with configuring financial account products, consistent with certain disclosed embodiments.

FIG. 12 is a block diagram of an exemplary process flow involving an exemplary client executing mobile application software to perform one or more operations and provide exemplary interfaces for configuring a financial account, consistent with certain disclosed embodiments.

FIG. 13 is a block diagram of another exemplary process flow involving an exemplary client executing mobile application software to perform one or more operations and provide exemplary interfaces relating to configuring financial account parameter(s), consistent with certain disclosed embodiments.

FIG. 14 is a flowchart of an exemplary financial card control process, consistent with disclosed embodiments.

FIG. 15 is a block diagram of an exemplary process flow involving an exemplary client executing mobile application software to perform one or more operations and provide exemplary interfaces relating to controlling a financial account, consistent with certain disclosed embodiments.

FIG. 16 is a block diagram of another exemplary process flow involving an exemplary client executing mobile application software to perform one or more operations and provide exemplary interfaces relating to shutting down a financial account, consistent with certain disclosed embodiments.

FIG. 17 is a block diagram of another exemplary process flow involving an exemplary client executing mobile application software to perform one or more operations and provide exemplary interfaces relating to locking a financial account, consistent with certain disclosed embodiments.

FIG. 18 is a block diagram of another exemplary process flow involving an exemplary client executing mobile application software to perform one or more operations and provide exemplary interfaces relating to configuring automatic locking of a financial account, consistent with certain disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

FIG. 1 is a diagram illustrating an exemplary system 100 for performing one or more operations consistent with the disclosed embodiments. In one embodiment, system 100 may include a financial service provider 110, client 120, merchant 150, and network 140. The components and arrangement of the components included in system 100 may vary. Thus, system 100 may further include other components that perform or assist in the performance of one or more processes consistent with the disclosed embodiments.

Financial service provider 110 may be an entity that provides financial services. For example, financial service provider 110 may be a bank, credit card issuer, or other type of financial service entity that offers, issues, generates, provides, manages, and/or maintains financial service accounts for one or more users. Financial service accounts may include, for example, credit card accounts, checking accounts, savings accounts, reward accounts, loan accounts (e.g., general (e.g., general purpose use) and specific (e.g., automobile, home improvement, mortgage, etc.)), lines of credit, promotional financing accounts, long term financing accounts, transactional credit accounts, installment loan accounts, and any other types of financial service account known to those skilled in the art. Financial service accounts may be associated with electronic accounts, such as a digital wallet or similar account that may be used to perform electronic transactions, such as purchasing goods and/or services online.

Financial service accounts may also be associated with one or more financial account products, such as physical financial service account cards (e.g., a plastic card or similar type of card product) that a user may carry on their person and use to perform financial service transactions, such as purchasing goods and/or services at a point of sale (POS) terminal. Financial account products may also include electronic type of account products, such as a mini card, or other type of product that may be configured to work with a computing system (e.g., mobile device) to operate like a physical financial account card. Financial service provider 110 may include infrastructure and components that are configured to generate and provide financial service accounts and financial account products (e.g., physical credit cards, check cards, mini cards, digital wallet accounts, etc.). Moreover, as explained, the disclosed embodiments are not limited to financial service accounts or financial service providers. That is, financial service provider 110 may, where other types of accounts or products are implemented, represent an entity that provides other types of accounts or products that may be configured, activated, and/or controlled in a manner consistent with the disclosed embodiments. One of ordinary skill in the art would understand that in such implementations, the operations of financial service provider 110 (and its components) as described herein may vary based on the type of entity and the type of accounts or products implemented by the disclosed embodiments.

In one embodiment, financial service provider 110 may include one or more computing systems that are configured to execute software instructions stored on one or more memory devices to perform one or more operations consistent with the disclosed embodiments. In one embodiment, financial service provider 110 may include server 111. Server 111 may be one or more computing devices configured to execute software instructions stored in memory to perform one or more operations consistent with the disclosed embodiments.

For example, server 111 may include one or more memory device(s) storing data and software instructions and one or more processor(s) configured to use the data and execute the software instructions to perform server-based functions and operations known to those skilled in the art and related to the function and operations of the type of businesses performed by financial service provider 110 (or other type of entity component 110 may represent). In one embodiment, server 111 may also be configured to execute stored software instructions to perform operations associated with configuring, controlling, activating, deactivating, temporarily locking, unlocking, and/or otherwise configuring financial accounts and financial account products consistent with the disclosed embodiments. Moreover, in certain embodiments, server 111 may be configured to execute software instructions that interact with software program(s) stored and executed by client 120, such as a mobile application that is executed on a mobile device.

Server 111 may be a general purpose computer, a mainframe computer, or any combination of these components. In certain embodiments, server 111 (or a system including server 111) may be configured as a particular apparatus, system, and the like based on the storage, execution, and/or implementation of the software instructions that perform one or more operations consistent with the disclosed embodiments. Server 111 may be standalone, or it may be part of a subsystem, which may be part of a larger system. For example, server 111 may represent distributed servers that are remotely located and communicate over a network (e.g., network 140) or a dedicated network, such as a LAN, for financial service provider 110.

Server 111 may include or may connect to one or more storage devices configured to store data and/or software instructions used by one or more processors of server 111 to perform operations consistent with disclosed embodiments. For example, server 111 may include memory configured to store one or more software programs that performs several functions when executed by a processor. The disclosed embodiments are not limited to separate programs or computers configured to perform dedicated tasks. For example, server 111 may include memory that stores a single program or multiple programs. Additionally, server 111 may execute one or more programs located remotely from server 111. For example, server 111 may access one or more remote programs stored in memory included with a remote component that, when executed, perform operations consistent with the disclosed embodiments. In certain aspects, server 111 may include web server software that generates, maintains, and provides web site(s) that are accessible over network 140. In other aspects, financial server provider 110 may connect separate web server(s) or similar computing devices that generate, maintain, and provide web site(s) for financial service provider 110.

Network 140 may be any type of network configured to provide communications between components of system 100. For example, network 100 may be any type of network (including infrastructure) that provides communications, exchanges information, and/or facilitates the exchange of information, such as the Internet, a Local Area Network, or other suitable connection(s) that enables the sending and receiving of information between the components of system 100. In other embodiments, one or more components of system 100 may communicate directly through a dedicated communication link(s), such as the exemplary links between financial service provider 110 and merchant 150.

Client 120 may be one or more computing devices that are configured to execute software instructions for performing one or more operations consistent with the disclosed embodiments. Client 120 may be a desktop computer, a laptop, a server, a mobile device (e.g., tablet, smart phone, etc.), and/or any other type of computing device. Client 120 may include one or more processors configured to execute software instructions stored in memory, such as memory included in client 120. Client 120 may include software that when executed by one or more processors performs known Internet-related communications and content display processes. For instance, client 120 may execute browser software that generates and displays interfaces including content on a display device included in, or connected to, client 120. The disclosed embodiments are not limited to any particular configuration of client 120. For instance, client 120 may be a mobile device that stores and executes mobile applications that provide financial service related functions offered by financial service provider 110 and/or merchant 150, such as a mobile banking application for controlling, configuring, and viewing information relating to financial accounts, etc. In certain embodiments, client 120 may be configured as a particular apparatus, system, and the like based on the storage, execution, and/or implementation of the software instructions that perform one or more operations consistent with the disclosed embodiments.

In one embodiment, a user 101 may provide input to client 120 that is used by software executed by client 120 to perform one or more operations consistent with the disclosed embodiments. In one aspect, user 101 may be a customer or a potential customer of financial service provider 110. For instance, financial service provider 110 may generate and maintain a financial service account (e.g., credit card account, a line of credit, etc.) for user 101 such that user 101 may use the account to purchase goods and/or services online or at brick and mortar locations associated with a merchant, such as merchant 150. In other embodiments, user 101 may be a potential customer of financial service provider 110 or may not be affiliated with financial service provider 110 from the user's perspective and/or financial service provider 110's perspective. Financial service provider 110 may be configured with infrastructure that generates and provides financial account products (e.g., plastic financial account cards) associated with a particular financial account. In certain embodiments, financial service provider 110 may be configured to create and provide a generic financial account product to user 101 that may be configured by user 101 to be associated with a particular type of financial account, such as a credit card, line of credit, generic financial loan account, specific financial loan account (e.g., automobile loan, product specific loan,) installment loan account, debit card, rewards account, loyalty account, etc.

Merchant 150 may be an entity that provides goods and/or services for purchase by consumers (e.g., individuals, businesses, etc.). While FIG. 1 shows one merchant 150, in system 100, the disclosed embodiments may be implemented in a system involving multiple and different merchants (e.g., a restaurant merchant and a grocery store merchant, and a retail store merchant, etc.). Merchant 150 may include brick and mortar location(s) that a consumer (e.g., user 101) may physically visit and purchase goods and services. Such physical locations may include computing devices that perform financial service transactions with consumers (e.g., POS terminal(s), kiosks, etc.). They may also include back and/or front-end computing components that store data and execute software instructions to perform operations consistent with disclosed embodiments, such as computers that are operated by employees of merchant 150 (e.g., back office systems, etc.). In certain embodiments, merchant 150 may also include one or more merchants that provide electronic shopping mechanisms, such as a website or similar online location that consumers may access using a computer (e.g., client 120) through browser software or similar software.

In one embodiment, merchant 150 may include server 151. Server 151 may be one or more computing devices configured to execute software instructions stored in memory to perform one or more processes consistent with the disclosed embodiments. For example, server 151 may include one or more memory device(s) storing data and software instructions and one or more processor(s) configured to use the data and execute the software instructions to perform server-based functions and operations known to those skilled in the art. Server 151 may be a general purpose computer, a mainframe computer, or any combination of these components. In certain embodiments, server 151 (or a system including server 111) may be configured as a particular apparatus, system, and the like based on the storage, execution, and/or implementation of the software instructions that perform one or more operations consistent with the disclosed embodiments. Server 151 may be standalone, or it may be part of a subsystem, which may be part of a larger system. For example, server 151 may represent distributed servers that are remotely located and communicate over a network (e.g., network 140) or a dedicated network, such as a LAN, for merchant 150.

In certain aspects, server 151 may include web server software that generates, maintains, and provides web site(s) for a respective merchant 150 that is accessible over network 140. In other aspects, merchant 150 may connect separate to web server(s) or similar computing devices that generate, maintain, and provide web site(s) for merchant 150. For example, merchant 150 may use web server(s) that provide a web site specific to merchant 150, and allows user 101 to access, view, and purchase goods and/or services from merchant 150.

FIG. 2 shows an exemplary computing system including server 111 for financial service provider 110, consistent with certain disclosed embodiments. In one embodiment, server 111 may include one or more processors 221, one or more memories 223, and one or more input/output (I/O) devices 222. Alternatively, server 111 may take the form of a general purpose computer, a mainframe computer, or any combination of these components. In certain embodiments, server 111 (or a system including server 111) may be configured as a particular apparatus, system, and the like based on the storage, execution, and/or implementation of the software instructions that perform one or more operations consistent with the disclosed embodiments. Server 111 may be standalone, or it may be part of a subsystem, which may be part of a larger system.

Processor 221 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in server 111.

Memory 223 may include one or more storage devices configured to store instructions used by processor 221 to perform functions related to disclosed embodiments. For example, memory 223 may be configured with one or more software instructions, such as program(s) 224 that may perform one or more operations when executed by processor(s) 221. The disclosed embodiments are not limited to separate programs or computers configured to perform dedicated tasks. For example, memory 223 may include a single program 224 that performs the functions of the server 211, or program 224 could comprise multiple programs. Additionally, processor 221 may execute one or more programs located remotely from server 211. For example, financial service provider 110, via server 111, may access one or more remote programs that, when executed, perform functions related to certain disclosed embodiments.

Memory 223 may also store data 225 that may reflect any type of information in any format that the system may use to perform operations consistent with the disclosed embodiments.

I/O devices 222 may be one or more device that is configured to allow data to be received and/or transmitted by server 111. I/O devices 222 may include one or more digital and/or analog communication devices that allow server 111 to communicate with other machines and devices, such as other components of systems 100.

Server 111 may also be communicatively connected to one or more database(s) 227. Server 111 may be communicatively connected to database(s) 227 through network 140. Database 227 may include one or more memory devices that store information and are accessed and/or managed through server 111. By way of example, database(s) 227 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, server 111 as exemplified in FIG. 2 may include database 227. Alternatively, database 227 may be located remotely from the server 111. Database 227 may include computing components (e.g., database management system, database server, etc.) configured to receive and process requests for data stored in memory devices of database(s) 227 and to provide data from database 227.

FIG. 3 shows an exemplary client 120 consistent with certain disclosed embodiments. In one embodiment, client 120 may include one or more processors 321, one or more memories 323, and one or more input/output (I/O) devices 322. In one embodiment, client 120 may take the form of a general purpose computer, a mainframe computer, or any combination of these components. In certain embodiments, client 120 (or a system including client 120) may be configured as a particular apparatus, system, and the like based on the storage, execution, and/or implementation of the software instructions that perform one or more operations consistent with the disclosed embodiments. Client 120 may be standalone, or it may be part of a subsystem, which may be part of a larger system.

Processor 321 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in client 120.

Memory 323 may include one or more storage devices configured to store instructions used by processor 321 to perform functions related to the disclosed embodiments. For example, memory 323 may be configured with one or more software instructions, such as program(s) 324 that may perform one or more operations when executed by processor 321. The disclosed embodiments are not limited to separate programs or computers configured to perform dedicated tasks. For example, memory 323 may include a single program 324 that performs the functions of client 120, or program 324 could comprise multiple programs. Additionally, processor(s) 321 may execute one or more programs located remotely from client 120. For example, client 120, may access one or more remote programs that, when executed, perform functions related to certain disclosed embodiments.

Memory 323 may also store data 325 that may reflect any type of information in any format that the system may use to perform operations consistent with the disclosed embodiments.

I/O devices 322 may be one or more device that is configured to allow data to be received and/or transmitted by server 311. I/O devices 322 may include one or more digital and/or analog communication devices that allow server 311 to communicate with other machines and devices, such as other components of system 100.

In certain embodiments, memory 323 may store a mobile banking application 325. Mobile banking application may be one or more programs or software instructions that, when executed by processor(s) 321, perform one or more mobile banking operations. For example, mobile banking application 325 may be a mobile application that is stored in a mobile device (e.g., client 120) that performs operations and generates interface(s) that are displayed on a display device of client 120. The interface(s) may be configured to present information and provide request(s) that elicit input from user 101. Client 120 may be configured with known input hardware and software components that accept input from user 101 through known mobile device mechanisms, such as touch screen technologies, voice input, keypad entry, etc. Mobile banking application 325 may be configured to use information associated with the user 101 input to generate information, analyze and determine condition(s), generate results based on those condition(s), and provide data and interface(s) including the data. In certain aspects, mobile banking application 325 may be configured to perform one or more processes consistent with the disclosed embodiments, such as, for example, configuring, activating, controlling, viewing, etc. a financial account and associated financial account product(s).

FIG. 4 shows a block diagram of one or more process flows associated with an exemplary arrangement consistent with disclosed embodiments. In one aspect, financial service provider 110 may create, generate, and provide one or more generic financial account card(s) 410 to user 101 using known delivery mechanisms and processes (415). In another aspect, server 111 may be configured to generate and provide financial account information to client 120 over, for example, network 140. Server 111 may be configured to execute software instructions that determine the credit worthiness of user 101 using known credit assessment processes, algorithms, and the like. Server 111 may also be configured to determine and provide to client 120, based on the credit worthiness of user 101, remote control account option(s) (420), consistent with disclosed embodiments. As shown in exemplary form, client 120 may be a laptop, desktop computer, or a mobile device (e.g., smart phone or tablet), but client 120 may include any type of computing device configured to execute software instructions to perform one or more processes consistent with the disclosed embodiments. Client 120 may also be configured to execute software instructions that generate and provide results from selections by user 101 relating to the remote control account option(s) (420) provided by financial service account provider 110 (430). Financial service account provider 110 may configure and manage one or more financial accounts for user 101 based on the selection results (430) provided by client 120.

FIG. 5 shows a block diagram of one or more process flows associated with another exemplary arrangement consistent with disclosed embodiments. In this embodiment, the exemplary system arrangement includes merchant 140. In one aspect, merchant 150 may create, generate, and provide one or more generic financial account card(s) 410 to user 101 using known delivery mechanisms and processes (515). In one aspect, merchant 150 may have an arrangement with financial service provider 110 to generate, provide, and manage financial accounts that are originated from merchant 150. Thus, as an example, merchant 150 may notify financial service provider 110 (e.g., via server 151 and server 111 or by other known communication mechanisms) that merchant 150 has issued a generic financial account card(s) 410 to user 101. Based on that notification, or an indication that card(s) 410 were provided to user 101, financial service provider 110 (via for example, server 111) may be configured to determine and provide to client 120 remote control account option(s)(520), consistent with disclosed embodiments. Client 120 may also be configured to execute software instructions that generate and provide results from selections by user 101 relating to the remote control account option(s) (520) provided by financial service account provider 110 (530). Financial service account provider 110 may configure and manage one or more financial accounts for user 101 based on the selection results (530) provided by client 120. Alternatively or additionally, client 120 may be configured to execute software instructions that generate and provide to merchant 150 (via server 151) results from selections by user 101 relating to the remote control account option(s) (520) provided by financial service account provider 110 (535). Merchant 150 may, via server 151, forward the user 101's selections to financial service provider 110 (via network 140 or though other communication mechanisms). Financial service account provider 110 may configure and manage one or more financial accounts for user 101 based on the selection results (535) provided by client 120 from merchant 150.

FIG. 6 shows a flowchart of an exemplary financial service provider remote control configuration process, consistent with disclosed embodiments. In one embodiment, financial service provider 110, via, for example server 111, may determine user's remote control account options for user 101 (step 610). In one aspect, server 111 may be configured to execute software instructions to determine the credit worthiness regarding user 101 using known credit evaluations software processes and based on known credit worthiness-related information. For example, financial service provider 110 may collect credit scores from credit agencies, review credit history information provided by user 101 or other sources, etc. to determine the financial account option(s) available to user 101 by financial service account 110.

Based on the evaluation of the user 101, server 111 may determine that user 101 is eligible for one or more financial accounts offered by financial service provider (e.g., user 101 may be eligible for credit card account(s), line of credit account(s), certain types of loan(s), and the like). In one aspect, server 111 may generate user 101 remote control account data that may include data associated with each financial account that financial service provider 110 may offer to user 101.

In some embodiments, the financial service provider remote control configuration process may further include generating and providing the user's remote control account configuration options (step 620). The configuration process may also include receiving the user's selection of a remote control account configuration option (step 630). Further, the configuration process may include configuring and creating a financial account in accordance with the received user's remote control account configuration option (step 640).

FIG. 7 shows a block diagram of an exemplary data structure for exemplary user 101 remote control account data 740, consistent with certain disclosed embodiments. In one aspect, the remote control account data 740 may includes data reflecting the option(s) available to user 101 regarding one or more types of financial accounts. In the example shown in FIG. 7, remote control account data 740 may include credit card option(s) data 741, which may include information for each credit card account that financial service provider 110 may provided to user 101, such as the identity and characteristics (e.g., type of account) of each associated credit card account that user 101 is approved for and may receive and one or more parameters associated with each credit card account. Likewise, line of credit option(s) data 742 may include the identity of each approved line of credit account for user 101 and associated parameter(s). General loan option(s) data 743 may include the identity, characteristics, and parameter(s) of any general loans that financial service provider 110 may provide to user 101. A general loan may include a financial account associated with a loan that may be used by user 101 for any general purpose (e.g., purchase product(s) or services, etc.). Specific loan option(s) data 744 may include the identity, characteristics, and parameter(s) of any specific loans that financial service provider 110 may provide to user 101. A specific loan may include a financial account associated with a loan that may be used by user 101 for a specific purpose (which may be specified in the characteristics data for option(s) data 744), such as an automobile loan, a service specific loan (home improvement loan), etc. Debit card option(s) data 745 may include the identity, characteristics, and parameter(s) of any debit card financial accounts that financial service provider 110 may provide to user 101. Other option(s) data 746 may reflect any other type of financial account, and its characteristics, identity, and parameters for that financial account.

The disclosed embodiments are not limited to the types of financial account option(s) data included in user 101 remote control account data 740 data structure. Any type of financial account option(s) data may be included in account data 740. Thus, in certain embodiments, server 111 may not generate and store any of the option(s) data exemplified in FIG. 7 if server 111 determines that user 101 is not eligible to receive such financial accounts. Further, the configuration, format, and arrangement of the financial account option(s) data shown in FIG. 7 are exemplary, and the disclosed embodiments are not limited to the types, configuration, and/or format shown in FIG. 7.

As an example, FIG. 8 shows a block diagram of an exemplary data structure relationship associated with credit card option(s) data 741, consistent with certain disclosed embodiments. As shown, credit card option(s) data 741 may include one or more parameter option(s) (e.g., option(s) 810-X). In one aspect, the parameter option(s) for credit card option(s) data 741 may reflect one or more parameter(s) for one type of credit card account that financial service provider 110 has approved and may offer to user 101. In the example of FIG. 8, financial service provider 110 has approved user 101 for single credit card account that may be configured with one or more different parameter(s), such as a credit limit (e.g., parameter option 810), interest rate (e.g., parameter option 820)), penalty fee parameter(s) (e.g., parameter option 830), and any other parameter(s) that financial service provider 110 may configure and offer to user 101 (e.g., parameter option X).

In one embodiment, the parameter option(s) associated with credit card option(s) data 741 may be specifically defined, such as a specific credit limit, specific interest rate, specific conditions for penalty fee(s) (e.g., late fee amount, etc.), and the like. In other embodiments, the parameter option(s) associated with credit card option(s) data 741 may be conditionally defined. For instance, parameter option(s) data 810 may reflect a range of credit limits that user 101 may select when configuring the general financial account card in accordance with the disclosed embodiments. In one example, server 111 may configure the parameter option(s) such that they are linked to other parameter option(s). For instance, a credit limit parameter of $2000 may be linked to one or more interest rate parameters (e.g., parameter option(s) 820), and so forth. Thus, a credit card financial account for user 101 may be configured such that a specific interest rate (and other parameter(s)) is associated with a credit limit as selected by user 101 (e.g., if user configures the credit card financial account to have a $2000 credit limit, the remote control account data 740 may automatically link a specific interest rate to that credit limit). The configuration, format, and/or arrangement of how the parameter option(s) 810-X is linked to each other for credit card option(s) data 741 may vary (e.g., linked fields, hash tables, associated tables, etc.).

Server 111 may be configured to generate remote control account configuration options based on the generated and stored remote control account data 740, and provide this information to client 120 (e.g., via network 140).

FIG. 9 shows a flow chart of an exemplary client remote control configuration process, consistent with certain disclosed embodiments. In one aspect, client 120 may receive from server 111, user 101's remote control account configuration option(s) 910 (step 910). Client 120 may store the received information and execute software applications that process the information to generate and display one or more interfaces on a display device of client 120 account configuration options (step 920). The account configuration options may be generated in a format that allows user 101 to view and select the type of financial account that user 101 wishes to associate and configure for the received general financial account card. The account configuration option(s) may include a number of options that user 101 may select through interfaces generated by client 120 through software executed by one or more processor(s) (e.g., processor(s) 321). Client 120 may present parameter option(s) that user 101 may select for the type of financial account selected by user 120 through the displayed interfaces. Client 120 receives user 101's selection(s) of the available account configuration options (step 930).

Based on user 101's selection(s) regarding the type of financial account and optionally the parameter(s) for the selected type of financial account, client 120 may generate a response that includes the user 101's selection of the account option(s) and provide the response to server 111 (e.g., over network 140) for processing (step 940). For example, based on the received response from client 120, server 111 may create and activate a financial account that is associated with the general financial card (e.g., 410) provided to user 101.

FIG. 10 shows a flowchart of an exemplary financial account parameter selection process consistent with disclosed embodiments. As explained, client 120 may be configured to execute software instructions that provide option(s) to user 101 for configuring the financial account to be associated with the general financial account card (e.g., 410) received from financial service provider 110 (or merchant 150). In one embodiment, client 120 may execute software that generates interface(s) providing the option(s) to user 101 based on the configuration information provided by server 111 in the remote control account configuration options sent to client 120. In one embodiment, client 120 may execute software that dynamically configures the financial account for the general financial account product based on selection(s) and/or input from user 101. In other embodiments, certain option(s) are static in that they are preconfigured by server 111 and are displayed through client 120 to user 101 for confirmation (e.g., user 101 can accept a preconfigured parameter(s) for a predetermined type of financial account or can dynamically change the parameter(s)). Client 120 may use the parameter option(s) (e.g., options 810-X) associated with a particular type of options data (e.g., 741-746) that may be included in the remote control account configuration options sent to client 120 by server 111. One or more of the steps of FIG. 10 may be associated with an interface(s) that client 120 generates and displays based on processing the remote control account configuration options and input from user 101.

In one aspect, in step 1010, client 120 may receive user 101's selection of a card type for the general financial account card (e.g., credit card type, line of credit type, debit card type, etc.). Client 120 may determine whether the financial account card can be dynamically configured for user 101 (step 1015). If not, client 120 may determine and display financial account parameter option(s) based on the selected card type (step 1020). For instance, client 120 may generate and display preconfigured credit card parameters that user 101 may select for the general financial account product. Client 120 may receive user 101's selected option through the displayed interface(s) (step 1022) and based on this selection, generates and provides user 101's selected account configuration option to server 111 (step 1024).

However, if client 120 determines that the selected card type in step 1010 may be dynamically configured by user 101 (step 1015; Yes), client 120 may determine the available parameter options for the selected card type based on the parameter option(s) (e.g., 810-X) associated with the account option(s) (e.g., 741-746) for the selected card type (e.g., credit card parameter options that user 101 may configure). In one embodiment, client 120 may allow user 101 to input a value for a particular parameter(s) (e.g., enter a specific requested credit limit) based on limits shown to user 101 (e.g., user can select a range of credit limits to enter). Client 120 may receive user 101's parameter input (e.g., interest rate, credit limit amount, etc.) (step 1035) and determine and display, based on that input, financial account parameters for the selected card type (step 1040). In one embodiment, client 120 may dynamically determine and display different parameter(s) for the selected card type based on the user 101's input. For example, user 101 may enter a requested credit limit of $2000 to be associated with the general financial account card, that user 101 has previously selected to be a credit card based on options provided in step 1010. Based on the $2000 credit limit value, client 120 may analyze the parameter option(s) (e.g., 810-X) using the relationship(s) between the parameter option(s) and rules stored in client 120 (or provided by server 111 in the remote control account configuration options sent to client 120 by server 111). Based on the analysis and the user 101's input, client 120 may determine and display other parameter(s) for the card type (e.g., the selected credit card may have a 9% APR if user 101 selects a $2000 credit limit, but may have a 5% APR if user 101 selects a higher or lower credit limit, etc.).

Client 120 may generate and display an interface requesting that the user accept the provided parameter(s) for the selected card type (e.g., step 1050). If user 101 does not accept the parameter(s), the process may return to step 1035 to request another parameter input from user 101 (e.g., change the selected credit limit to $1000). If, however, user 101 accepts the configured parameter(s) for the selected card type (e.g., step 1050; Yes), client 120 may generate and provide user 101's selected account configuration option to server 111 based on the determined financial account parameters for the selected card (step 1060). Server 111 may configure the financial account for the general financial account product such that user 101 may use the account product as configured (e.g., use the general financial account card as a credit card with the configured parameters accepted by user 101).

As explained, certain disclosed embodiments may be implemented to operate with a mobile banking application (e.g., application 325) that is stored and executed by a mobile device (e.g., client 120). FIG. 11 shows an exemplary mobile device client 120 that includes an exemplary interface including options for user 101 to select for configuring the general financial account product consistent with disclosed embodiments. In one aspect, an interface 1110 may include options for user 101 to select a card type for the general financial account product (e.g., options 1111-1130). In one aspect, mobile device client 120 may execute a mobile banking application (e.g., application 325) that generates the exemplary interface 1110.

FIG. 12 shows an exemplary mobile device client 120 that provides an exemplary interface 1211 with exemplary card type options 1210-1230 that user 101 may select for configuring the general financial account product (e.g., 410). In one embodiment, user 101 may select a credit card option 1210, reflecting that user 101 may wish to have the received general financial account product to be configured as a credit card. In response to selecting credit card option 1210, client 120 may generate and display an interface 1215 that provides exemplary options that user 101 may select for the general financial account product. In one embodiment, client device 120 may present static options (like that disclosed above in connection with FIG. 10), that include preconfigured parameters for selection by user 101 (e.g., option 1 (1211) and option 2 (1212)). User 101 may select an option through client device 120, which may be processed by client 120 to generate the user's selected account configuration option provided to server 111.

FIG. 13 shows an exemplary mobile device client 120 that provides exemplary interfaces for providing dynamic parameter configurations operations consistent with disclosed embodiments. In one aspect, client 120 may receive a selection from user 101 of credit card option 1210, like that disclosed above in connection with FIG. 12. In this example, however, client 120 may execute software that provides dynamic configuration processes. For example, client 120 may generate and display a dynamic parameter configuration options interface 1315 that may include one or more input option(s) (e.g., 1311, 1312) that user 101 may use to input a parameter value for type of parameter (e.g., interest rate, credit limit, etc.). In the example of FIG. 13, user 101 enters a credit limit of $2000. In response, client 120 may execute software that, based on the user 101's input and rules and the linked relationship of the parameter option(s) (e.g., 810-X) for the selected card type, generates and displays one or more available options (e.g., option 1, 1322) including determined parameters for the selected card type. In this example, based on user 101's input of a credit limit of $2000, client 120 determines that the interest rate available for the selected card type maybe 4%. User 101 may accept the available option and client 120 in turn may generate and provide the user's selected account option(s) to server 111 for configuring and activating the financial account to be associated with the general financial account product (which may now be configured as a credit card).

Other embodiments of the disclosed embodiments may include mechanisms for allowing user 101 to control a financial account product and associated financial account that has been activated and provided by financial service provider 110 (or merchant 150). FIG. 14 shows a flow chart of an exemplary financial card control process that may be performed by disclosed embodiments. In one aspect, one or more processes of FIG. 14 may be performed by client 120. In one aspect, client 120 may execute a mobile banking application (e.g., 325) to perform one or more of the processes of FIG. 14. In one example, client 120 may provide, via interface(s) on client 120, options for user 101 to select and provide input for controlling a financial card. In one embodiment, client 120 may provide option(s) to allow user to permanently shut down a selected financial account and associated account product (e.g., card shut down 1410). Client 120 may generate and provide an option for user 101 to confirm the permanent shut down of the account and account product (e.g., step 1412), and subsequently generate and provide an indication of the selected shut down to server 111 (step 1414). In this exemplary process, user 101 may select, using client 120, and in some embodiments, a mobile application executing on client 120, a particular financial account and associated financial account card to be shut down such that it cannot be used for any purchase transactions. Server 111 may be configured to execute software instructions that receive the indication of the shut down from client 120 and configure the selected financial account such that is inactivated and prevented from being used for financial transactions.

In another embodiment, client 120 may execute software instructions that generate and provide options for user 101 to lock a selected financial account and associated account product in accordance with user selectable options (e.g., step 1420). In one aspect, client 120 may generate and provide card lock option(s) to user 101 via one or more interface(s) that enable user 101 to temporarily lock a selected financial account and associated account product such that the account and product cannot be used for financial transactions for selected period of time, or under selected conditions (step 1422). Client 120 may receive card lock option selection(s) from user 101 via one or more interfaces generated and displayed by client 120 (e.g., step 1424), and in response generate and provide the selected card lock options to server 1426 (step 1426). Server 111 may be configured to execute software instructions that in response to received selected card lock options, configures the selected financial account to be locked in accordance with the selected lock parameters relating to the user's selected options. For example, the disclosed embodiments enable user 101 to lock a credit card account and credit card product for a period of time (e.g., one day, one week, one month, etc.) based on the options provided by client 120. Server 111 may be configured to lock the credit card account such that it cannot be used for financial transactions in accordance with the user 101's selections.

In another embodiment, client 120 may generate and provide interface(s) that enable user 101 to unlock a previously locked financial account and associated account product (e.g., step 1430). Client 120 may generate and provide an option to user 101 to confirm that the selected financial account is to be unlocked (step 1432) and in response, client 120 may generate and provide an indication of the unlock selection to server 111 for processing (step 1434). Server 111 may be configured to execute software that unlocks a previously locked financial account in accordance with the disclosed embodiments (e.g., unlocks a credit card account that user 101 previously temporarily locked using the card lock option 1420).

In another embodiment, client 120 may generate and provide interface(s) that enable user 101 to configure automatic lock options for one or more selected financial accounts and associated account products (e.g., step 1440). In one aspect, client 120 may generate and provide interfaces to user 101 that provide automatic lock options to user 101 that include options that user 101 may select to have a selected financial account and account product to be automatically locked based on selected conditions (step 1442). For example, the disclosed embodiments may allow user 101 to configure an automatic lock condition that client 120 checks when client 120 is used to perform mobile banking operations associated with a particular financial account. Thus, for example, user 101 may configure an automatic locking option for a selected financial account and associated account product that determines when a financial account is used in a financial transaction that is outside user 101 selected geographic parameters (e.g., outside a zip code, etc.), or at undesignated merchant locations, etc. Client 120 and/or server 111 may be configured to determine when a designated financial account is being used to perform a financial transaction that violates user 101 configured conditions, and automatically lock the financial account and associated financial product until user 101 unlocks the account using the card unlock option (e.g., 1430) or another process for unlocking the account (e.g., calling a financial service provider 110 representative, online unlocking, etc.).

Client 120 may receive the selected automatic lock options from user 101 (step 1444) and in response, generate and provide the selected automatic lock options to server 111 for processing in accordance with the disclosed embodiments (step 1446).

FIG. 15 shows a block diagram of an exemplary mobile device client 120 including an exemplary interface 1505 for controlling a selected financial account and associated account product in accordance with disclosed embodiments. In one example, client 120 may execute a mobile banking application (e.g., 325) that generates interface(s) that user 101 may use to selectively control use of a designated account and account product. In one embodiment, client 120 may generate an interface 1505 that displays a list of one or more financial accounts that user 101 may hold with financial service provider 110 (e.g., options 1510-1530). User 101 may select a particular financial account that he/she wishes to control, and in response, client 120 may generate an exemplary interface (1510) that provides one or more options (e.g., 1511, 1512, 1513, and 1515) to control the designated financial account. In one embodiment, options 1511-1515 may correspond to respective processes 1410, 1420, 1430, and 1440, disclosed above in connection with FIG. 14.

FIG. 16 shows a block diagram of an exemplary mobile device client 120 including exemplary interfaces for controlling a selected financial account and associated account product in accordance with disclosed embodiments. In this example, client 120 may generate and provide options for shutting down a designated financial account and account product (e.g., option 1611 in interface 1610). Client 120 may generate and display an indication (1621) in an interface (e.g., 1620) that informs user 101 that the designated financial account and associated account product has been permanently inactivated and shut down from future financial transaction use.

FIG. 17 shows a block diagram of an exemplary mobile device client 120 including exemplary interfaces for controlling a selected financial account and associated account product in accordance with disclosed embodiments. In this example, client 120 may generate and provide options for locking a designated financial account and associated financial account product in accordance with selectable options. For instance, user 101 may select card lock option 1512 shown in interface 1510. In response, client 120 may generate and provide an interface 1715 that includes one or more options for selectively locking the designated financial account and account product. In one embodiment, client 120 may generate and display an option 1712 that allows user 101 to lock a designated financial account from use until user 101 unlocks the account using the card unlock option 1513. Client 120 may generate and display an option 1713 that allows user 101 to select a time period that the designated financial account and associated account product may be locked from use. As shown in FIG. 17, user 101 may generate an interface 1720 that allows user 101 to select a particular time period for locking the designated financial account in terms of days, hours, minutes, or an end date, although the disclosed embodiments may implement other time periods. Client 120 may also generate and display an option 1715 that may allow user 101 to selectively set geographic limits where the designated financial account and account product can be used. For instance, client 120 may generate and provide options to user 101 that enables user 101 to lock use of the designated financial account and account product outside a selected geographic zone (e.g., outside selected zip codes, etc.). Client 120 may be configured to send the locking option selections of user 101 to server 111. Server 111 may be configured to lock the designated financial account in accordance with the received selected options.

FIG. 18 shows a block diagram of an exemplary mobile device client 120 including exemplary interfaces for controlling a selected financial account and associated account product in accordance with disclosed embodiments. In this example, client 120 may generate and display an interface 1815 that allows user 101 to selection option(s) (e.g., options 1812, 1814) for configuring automatically locking conditions for a designated financial account and associated card. In one example, user 101 may select to configure geographic limits (1814) for locking the designated financial account. Client 120 may generate and provide an interface 1820 that enables user 101 to configure geographic limitations on the use of the designated financial account and associated account product. In one example, client 120 may generate and display options 1814-1816 that enable user 101 to enter zip codes where the designated financial account and associated account product may be used. Client 120 may also provide interface(s) that allow user 101 to select particular merchants where the designated financial account and account product may be user (e.g., by name, menu selection, etc.). Client 120, via for example mobile banking application 325, may provide the user 101's selections to server 111. Server 111 may be configured to configure tracking mechanisms that are triggered when one or more of the conditions associated with the user's automatic lock configuration selections are met. For example, server 111 may be configured to detect when a designated financial account is being used to purchase goods in a geographic location or at a merchant that user 101 has designated to be blocked. Server 111 may use merchant identifications and geographic location data associated with the purchase transactions to compare to the user 101's automatic locking configuration settings. If a condition is met, server 111 may lock the designated financial account and associated account product until user 101 unlocks the account in accordance with disclosed embodiments.

Other embodiments will be apparent to those skilled in the art from consideration of the specification and practice of the disclosed embodiments. It is intended that the specification and examples be considered as exemplary only, with a true scope and spirit of the disclosed embodiments being indicated by the following claims. For example, in addition to stopping/starting card usage, the disclosed embodiments include systems and processes that enable user 101 to prescribe specific usage limits from client 120 (e.g., via mobile application program 325). In one embodiment, for example, client 120 may execute mobile application program 325 to provide interface(s) that give user 101 options for controlling use of a financial account product (e.g., credit card, etc.) based on selected merchant type (e.g., sporting good merchants, grocery store merchants, etc.), specific merchants (e.g., by merchant name), payment amount (e.g., limit on purchase amounts involving the financial account or account card), or time periods (e.g., range of time, specific dates, specified amount of time (e.g., minutes, hours, days, weeks, months), a range of days (e.g., Date 1 to Date 2), specified days of the week (e.g., financial account is locked on Saturdays and Sundays)), etc. The disclosed embodiments may be configured to execute software instructions that provide interfaces that request user 101 input regarding these and other options and based on the received input, may determine and generate financial account control information that is provided to server 111 for configuring the designated financial accounts in accordance with the user's selections.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

What is claimed is:

1. A system for configuring an inactive financial account, comprising:
one or more memory devices storing software instructions; and
one or more processors configured to execute the software instructions to:
receive financial account configuration option data from a server, the financial account configuration option data relating to a configurable inactive financial account product that is provided to a user,
generate and display one or more interfaces for configuring the inactive financial account product,
receive input through the one or more interfaces to configure the inactive financial account product,
generate user selected financial account configuration option data based on the input, and
provide the user selected financial account configuration option data to the server such that the server configures and activates the inactive financial account product in accordance with the user's input.

2. The system of claim 1, wherein the one or more processors are further configured to
provide an option to designate a type of financial account to be associated with the inactive financial account product;
receive a financial account type selection based on the option to designate the type of financial account; and
provide the user selected financial account configuration option data to the server such that the server configures the inactive financial account product as an active type of financial account product corresponding to the financial account type selection.

3. The system of claim 2, wherein type of financial account includes a credit card account, a line or credit account, a loan account, or a debit account.

4. The system of claim 2, wherein the system is a mobile device and the software instructions are associated with a mobile banking application executed by the one or more processors.

5. A computer-implemented method for configuring a financial account, comprising:
receiving, by one or more processors, financial account configuration option data from a server, the financial account configuration option data relating to a configurable inactive financial account product that is provided to a user;
generating, by the one or more processors, and displaying one or more interfaces for activating the inactive financial account product,
receiving, by the one or more processors, input through the one or more interfaces to activate the inactive general financial account product;
generating, by the one or more processors, user selected financial account configuration option data based on the input; and
providing, by the one or more processors, the user selected financial account configuration option data to the server such that the server configures and activates the inactive financial account product in accordance with the input.

6. The method of claim 5, further comprising:
providing, by the one or more processors, an option to designate a type of financial account to be associated with the inactive financial account product;
receiving, by the one or more processors, a financial account type selection; and
providing, by the one or more processors, the user selected financial account configuration option data to the server such that the server configures the inactive financial account product as an active type of financial account product corresponding to the financial account type selection.

7. The system of claim 6, wherein type of financial account includes a credit card account, a line or credit account, a loan account, or a debit account.

8. The system of claim 6, wherein the one or more processors execute a mobile banking application to perform one or more of the steps of claim 6.

9. A system for controlling a financial account, comprising:
one or more memory devices storing software instructions; and
one or more processors configured to execute the software instructions to:
provide a first interface on a mobile device that includes options for a user to shut down a designated financial account, lock the financial account, unlock the financial account, or configure automatic locking of the financial account,
receive a selection from the user of one of the options, and
provide the user's selection to a server that is configured to configure the designated financial account such that use of the designated financial account is selectively controlled based on the user's selected option.

10. The system of claim 9, wherein the one or more processors are further configured to:
receive a selection from the user to lock the designated financial account; and
provide an interface to allow the user to select one or more configuration parameters for temporarily locking the designated financial account, wherein the financial account is temporarily locked from use in financial transactions based on the user's selected one or more configuration parameters.

11. The system of claim 10, wherein the one or more processors are further configured to provide an interface to allow the user to select a time period for temporarily locking the designated financial account such that the financial account is temporarily locked from use in financial transactions for the selected time period.

12. The system of claim 9, wherein the designated financial account has been temporarily locked from use and wherein the one or more processors are further configured to:
receive a selection from the user through an interface to unlock the previously locked financial account; and
provide to the server an indication of the user's selection to unlock the previously locked financial account such that the server unlocks the previously locked financial account so that the financial account is usable in financial transactions.

13. A system for controlling a financial account, comprising:
one or more memory devices storing software instructions; and
one or more processors configured to execute the software instructions to:
receive a first selection from a user of a financial account;
generate and display one or more interfaces for enabling the user to control the use of the financial account;
receive input from the user through the one or more interfaces to control the use of the financial account, wherein the input received by the user through the one or more interfaces includes input to configure usage limits for the financial account identified by the user;
generate user selected financial account configuration option data based on the usage limits provided by the user; and
provide the user selected financial account configuration option data to a server such that the server controls use of the inactive financial account product in accordance with the user's provided usage limits.

14. The system of claim 13, wherein the usage limits include merchant type usage limits, merchant name usage limits, payment amount usage limits, or time period limitation usage limits.

15. The system of claim 14, wherein merchant type usage limits includes information indicating that use of the financial account product is precluded at one or more types of merchants identified by the user.

16. The system of claim 14, wherein merchant type usage limits includes information indicating that use of the financial account product is allowed at one or more types of merchants identified by the user.

17. The system of claim 14, wherein payment amount usage limits includes information indicating that use of the financial account product involving a financial transaction over a predetermined purchase amount is not allowed.

18. The system of claim 14, wherein payment amount usage limits includes information indicating that use of the financial account product involving a financial transaction under a predetermined purchase amount is allowed.

19. The system of claim 14, wherein time period limitation usage limits include information indicating that use of the financial account product involving a financial transaction is not allowed during a determined period of time, a determined day of week, a determined time of day, or before a determined date.

20. The system of claim 14, wherein time period limitation usage limits include information indicating that use of the financial account product involving a financial transaction is allowed during a determined period of time, a determined day of week, a determined time of day, or on a determined date.

21. The system of claim 14, wherein merchant name usage limits include information indicating that use of the financial account product is allowed at one or more merchants identified by the user.

22. The system of claim 14, wherein merchant name usage limits include information indicating that use of the financial account product is not allowed at one or more merchants identified by the user.
